(19) United States
(12) Patent Application Publication
(10) Pub. No.: US 2009/0327793 A1
(43) Pub. Date: Dec. 31, 2009

(54) FINITE IMPULSE RESPONSE (FIR) FILTER WITHOUT DECIMATION

(75) Inventors: Jin-hyun Kim, Dajeon-si (KR); Jin-Soo Park, Suwon-si (KR); Hyung-sun Lim, Hwaseong-si (KR); Han-Woong Yoo, Seoul (KR); Young-Eil Kim, Suwon-si (KP); Bum-Man Kim, Pohang-si (KR); Chang-Joon Park, Pohang-si (KR)

Correspondence Address: DLA PIPER LLP US, P. O. BOX 2758, RESTON, VA, 20195, US

(73) Assignee: SAMSUNG ELECTRONICS CO., LTD., Suwon-si (KR)

(21) Appl. No.: 12/355,182

(22) Filed: Jan. 16, 2009

(30) Foreign Application Priority Data
Jun. 27, 2008 (KR) 10-2008-0061566

(51) Int. Cl. G06F 17/10; G06F 1/06

(52) U.S. Cl. 713/501; 708/300

(57) ABSTRACT

Provided is a discrete signal finite impulse response (FIR) filter and a filter set in which a plurality of FIR filter units are connected in a cascade structure to remove down-sampling by decimation, in order to improve the attenuation characteristics of a FIR filter, such as, for example, a switched capacitor filter. The FIR filter includes a clock generator generating a plurality of clock signals that are different from each other; and N+2 sub blocks each including N sample storage units, each sample storage unit storing a received sample. Each sub block being in a state among a number of possible states including N charging states for storing the received sample, a transfer state for outputting the stored sample and a reset state for operation initialization. The N charging states, the transfer state and the reset state are changed sequentially in response to the clock signals.

### CROSS REFERENCE TO RELATED APPLICATIONS

This application claims priority from Korean Patent Application No. 10-2008-0061566, filed on Jun. 27, 2008, the disclosure of which is incorporated herein in its entirety by reference.

### TECHNICAL FIELD

The present invention relates to a finite impulse response (FIR) filter, and more particularly, to a finite impulse response (FIR) filter without decimation.

### DESCRIPTION OF THE RELATED ART

A finite impulse response (FIR) filter performs filtering using only input signal values. An impulse response which is the characteristic function of such a FIR filter has a finite length. FIR filters have been widely utilized in various digital devices, particularly, for the purpose of varying the phase of an input signal without changing the waveform of the input signal.

A conventional FIR filter filters an input signal using a moving average characteristic. Upon filtering, the conventional FIR filter operates based on a moving average formula, with a difference between an input sampling rate and an output sampling rate, and accordingly decimation occurs inevitably.

For example, when an input sampling rate of a FIR filter is 1 sample every 1 period, if during 4 periods, that is, while 4 samples are received, a single output is generated, a decimation value of the FIR filter will become 4. In other words, decimation is the characteristic of a filter occurring when an input sampling rate is different from an output sampling rate. The magnitude of decimation is determined by a system specification considering a sampling frequency which can be processed by a sampler, a sampling frequency which can be processed by an analog-to-digital converter (ADC), etc.

Meanwhile, in regard to a discrete-time receiver system, recently, demands for a FIR filter which can be applied to a broadband system and for techniques for improving attenuation of a FIR filter are increasing.

A simplest method for satisfying the demands is to connect a plurality of FIR filters in a cascade structure. However, in the case of connecting conventional FIR filters in series, there is a problem that additional decimation is generated due to different sample rates between input and output signals.

### SUMMARY OF DISCLOSURE

The present invention provides a finite impulse response (FIR) filter without decimation.

According to an aspect of the present disclosure, there is provided a finite impulse response (FIR) filter that may include: a clock generator generating a plurality of clock signals that are different from each other; and N+2 sub blocks each including N sample storage units, each sample storage unit storing a received sample, wherein each sub block has a state among N charging states for storing the received sample, a transfer state for outputting the stored sample, and a reset state for operation initialization, and the N charging states, the transfer state, and the reset state are changed sequentially in response to the clock signals.

Each clock signal may be used to control a charging state of a first sub block among the N+2 sub blocks, a reset state of a second sub block among the N+2 sub blocks, and a transfer state of a third sub block among the N+2 sub blocks.

Each clock signal may be a signal in which a unit pulse is repeated periodically, and a (n+1)-th clock signal among the plurality of clock signals is a signal delayed by a length of the unit pulse from a n-th clock signal among the plurality of clock signals.

Each sub block may include a first switch unit and a second switch unit. The first switch unit may control a charging state of the sub block in response to a clock signal generated by the clock generator. The second switch unit may control a transfer state or a reset state of the sub block in response to the clock signal.

The second switch unit may include a transfer switch and a reset switch. The transfer switch may be connected to an output terminal of the FIR filter. The reset switch may be connected to a reset terminal of the FIR filter.

According to another aspect, there is provided a finite impulse response (FIR) filter, which may include a clock generator and a plurality of sub blocks. The clock generator may generate a plurality of clock signals that are different from each other. The plurality of sub blocks may each have a state among N charging states for storing a received sample, a transfer state for outputting the stored sample, or a reset state for operation initialization. The N charging states, the transfer state and the reset state may be changed in response to a clock signal generated by the clock generator. At least one sub block among the plurality of sub blocks may be in the transfer state.

The clock signal generated by the clock generator may be used to control a charging state of a first sub block among the plurality of sub blocks, and may simultaneously control a transfer state or a reset state of a second sub block among the plurality of sub blocks.

Each sub block may include N sample storage units, a first switch unit and a second switch unit. The N sample storage units may store a received sample. The first switch unit may be connected to the N sample storage units, and may control a charging state of the sub block in response to a clock signal received from the clock generator. The second switch unit may be connected to the N sample storage units, and may control a transfer state or a reset state of the sub block in response to the clock signal.

According to yet another aspect, there is provided a finite impulse response (FIR) filter, in which a plurality of FIR filter units may be connected in a cascade structure, and which may include a plurality of sub blocks, each having a state among N charging states for storing a received sample, a transfer state for outputting the stored sample, and a reset state for operation initialization. The N charging states, the transfer state, and the reset state may be changed sequentially in response to an external clock signal. At least one sub block of the plurality of sub blocks may be in the transfer state. The FIR filter units of the above configuration can also be connected in a cascade structure to a conventional FIR filter exhibiting decimation.

The FIR filter may further include a clock generator generating a plurality of clock signals for controlling states of the plurality of FIR filter units.

Additional aspects of the invention will be set forth in the description which follows, and in part will be apparent from the description, or may be learned by practice thereof.

It is to be understood that both the foregoing general description and the following detailed description are exemplary and explanatory, intended to provide further explanation, but not as limiting, of the subject matter claimed.

### BRIEF DESCRIPTION OF THE DRAWINGS

The accompanying drawings, which are included to provide a further understanding of the invention and are incorporated in and constitute a part of this specification, illustrate the embodiments of the invention, and together with the description serve to explain various aspects of the invention, of which drawings:

FIG. 1 is a block diagram of a finite impulse response (FIR) filter according to an embodiment of the present invention;

FIG. 2 is a view for explaining states of the FIR filter illustrated in FIG. 1, according to an embodiment of the present invention;

FIG. 3 is a circuit diagram of a FIR filter according to an embodiment of the present invention;

FIG. 4 is a timing diagram of a clock signal that is to be applied to the circuit of the FIR filter illustrated in FIG. 3;

FIG. 5 is a construction diagram of a filter set according to another embodiment of the present invention;

FIG. 6 shows a filter set where a plurality of NDFs (No Decimation Filters) according to an embodiment of the present invention are connected to a conventional FIR filter, and frequency characteristics of the filter set;

FIG. 7 is a block diagram showing a clock generator of a NDF, according to an embodiment of the present invention, and a clock generator of a conventional FIR filter; and

FIG. 8 is a block diagram of a clock generator which NDFs and a conventional FIR filter share, according to another embodiment of the present invention.

### DETAILED DESCRIPTION OF SEVERAL EMBODIMENTS

Several embodiments are described more fully hereinafter with reference to the accompanying drawings. Aspects of the present disclosure may, however, be embodied in many different forms and should not be construed as limited to the embodiments set forth herein. Rather, these embodiments are provided so that this disclosure is thorough, and will fully convey the scope thereof to those skilled in the art. In the drawings, the size and relative sizes of layers and regions may be exaggerated for clarity. Like reference numerals in the drawings denote like elements.

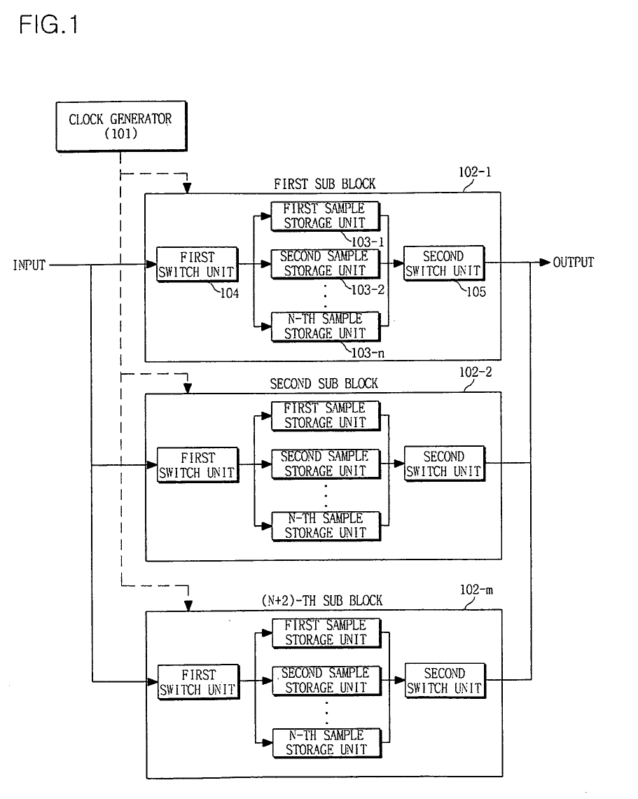

FIG. 1 is a block diagram of a finite impulse response (FIR) filter according to an embodiment of the present invention.

Referring to FIG. 1, the FIR filter includes a clock generator 101 and a plurality of sub blocks 102-1 through 102-m. Each sub block (for example, the sub block 102-1) can include a plurality of sample storage units 103-1 through 103-n, a first switch unit 104, and a second switch unit 105.

A FIR filter is used to change the characteristics of a signal. A FIR filter filters an input signal using a moving average method or a running average method.

For example, each of the sub blocks 102-1 through 102-m temporarily stores an input signal, calculates a moving average or running average of the stored signal and outputs the result of the calculation, under the control of the clock generator 101.

In the current embodiment, the FIR filter has N+2 sub blocks 102-1 through 102-m, and each sub block, for example, the sub block 102-1, has N sample storage units 103-1 through 103-n, wherein N is a decimation factor selected considering the specification of a system. The decimation factor may be a value related to the frequency characteristics of the FIR filter. For example, if a decimation value 3 is obtained as the result of analysis on a transfer function of a conventional down-sampling FIR filter, the N value is set to “3” when the FIR filter according to the current example is configured. In this example, 5 sub blocks are constructed and each sub block includes 3 sample storage units. Of course, even in this example, the N value can be set to a value (for example, “4”) greater than “3”, and also, can be set to an arbitrary value which does not influence the overall performance of the system.

The clock generator 101 generates a plurality of clock signals to control the sub blocks 102-1 through 102-m. The clock signals are different from each other. For example, each clock signal may be a signal in which a unit pulse is repeated periodically, and a (n+1)-th clock signal may be a signal delayed by the length of a unit pulse from a n-th clock signal.

Each of the sub blocks 102-1 through 102-m can store (sample or charge) an input signal, combine and transfer the stored input signal, or discharge (reset) the input signal for initialization, in synchronization to a clock signal of the clock generator 101. For example, each of the sub blocks 102-1 through 102-m has a charging state, a transfer state, or a reset state, and the states of the sub blocks 102-1 through 102-m may be changed in response to a clock signal of the clock generator 101.

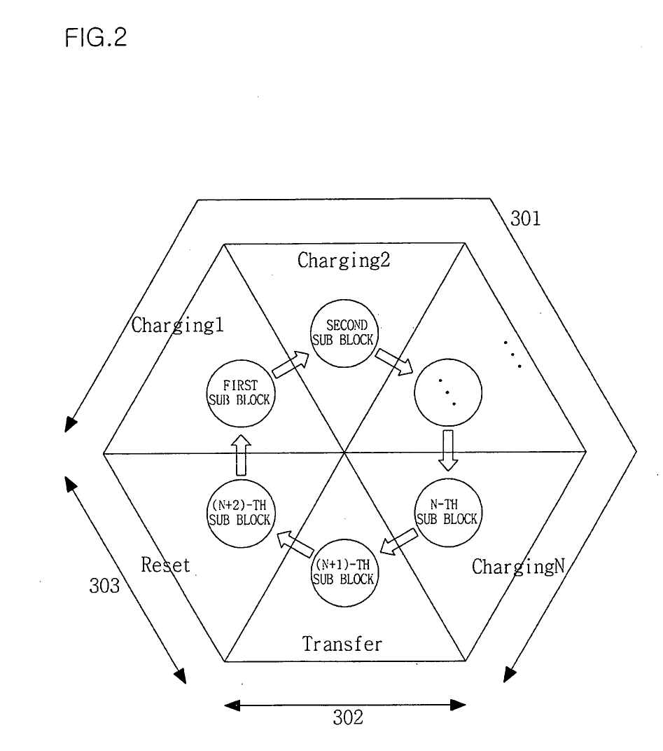

FIG. 2 illustrates the states of the FIR filter illustrated in FIG. 1 according to an embodiment. Referring to FIG. 2, the states of the FIR filter include N charging states 301, a transfer state 302, and a reset state 303.

Referring to FIGS. 1 and 2, since N sample storage units 103-1 through 103-n are provided for each sub block, N charging states 301 corresponding to the N sample storage units 103-1 through 103-n are provided. For example, when input signals are received at regular intervals, the input signals are stored sequentially in the first through N-th sample storage units 103-1 through 103-n. That is, a state in which an input signal is stored only in the first sample storage unit 103-1 is a first charging state, a state in which input signals are stored in both the first and second sample storage units 103-1 and 103-2 is a second charging state, . . . , a state in which input signals are stored in each of the first through N-th storage units 103-1 through 103-N is a N-th charging state. In the charging state 301, an input signal is sampled and temporarily stored to calculate a moving average or a running average.

In the transfer state 302, samples stored in the sample storage units 103-1 through 103-n are combined and transferred.

In the reset state 303, the operation of the system is initialized and the sample storage units 103-1 through 103-n are, e.g., grounded.

If a clock signal is received from the clock generator 101 when each of the sub blocks 102-1 through 102-m is in any one of the charging state, transfer state and reset state, the current states of the sub blocks 102-1 through 102-m can be changed in response to the clock signal. For example, as illustrated in FIG. 2, whenever a clock signal is applied to the respective sub blocks 102-1 through 102-m, the states of the sub blocks 102-1 through 102-m can be changed clockwise. That is, the state of a (N+1)-th sub block which is currently in the transfer state is changed to the reset state at the next time period, and the state of a N-th sub block can be changed to the transfer state at the next time period. If the clock signal is controlled so that the states of the sub blocks 102-1 through 102-m are changed whenever an input signal is received, at least one among the sub blocks 102-1 through 102-m is in the transfer state, and accordingly decimation can be removed.

Again referring to FIG. 1, changing the states of the sub blocks 102-1 through 102-m in this manner is performed by causing the clock generator 101 to control the first and second switch units 104 and 105 of each sub block 102-I through 102-m.

For example, it is assumed that in a FIR filter including three sub blocks (for example, first, second and third sub blocks 102-1, 102-2 and 102-3) each having a sample storage unit 103, a clock generator (not shown) generates three different clock signals (for example, T1, T2 and T3). In this case, the clock signal T1 is input to each of the first, second and third sub blocks 102-1, 102-2 and 102-3. For example, the clock signal T1 is applied to the first switch unit 104 of the first sub block 102-1 to control the charging state of the first sub block 102-1, simultaneously applied to the second switch unit 105 of the second sub block 102-2 to control the reset state of the second sub block 102-2, and also applied to the second switch unit 105 of the third sub block 102-3 to control the transfer state of the third sub block 102-3.

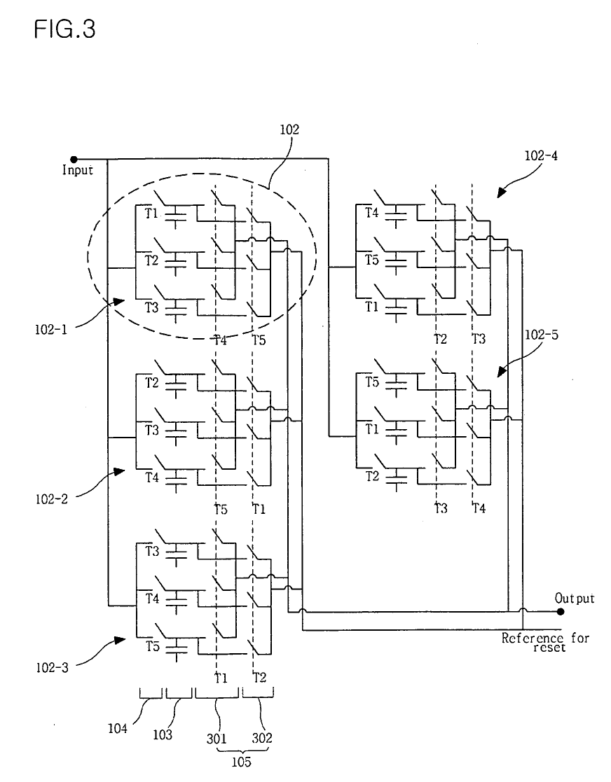

The operation of the FIR filter will be described in more detail below with reference to the circuit diagram of the FIR filter according to an embodiment shown in FIG. 3.

In FIG. 3, the reference number 102 denotes a sub block, and in the current embodiment, five sub blocks 102 are provided. Each sub block 102 includes three sample storage units 103, a sampling switch 104, a reset switch 302, and a transfer switch 301.

According to the embodiment, each sample storage unit 103 may be a switched capacitor connected to the sampling switch 104. The transfer switch 301 switchably connects the sample storage unit 103 to an output terminal. The reset switch 302 switchably connects the sample storage unit 103 to, e.g., a ground.

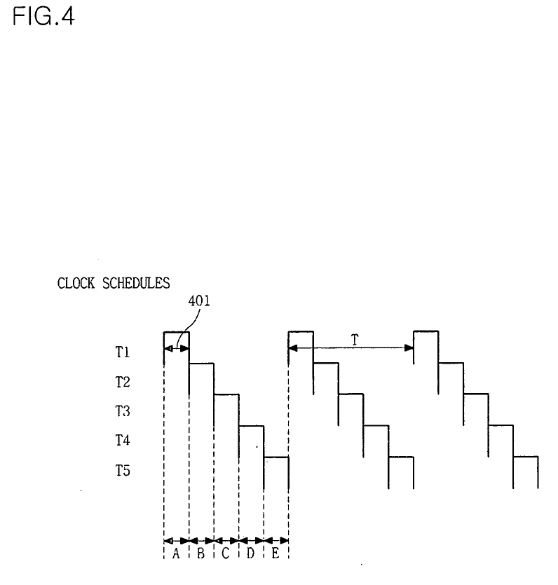

A clock signal generated by the clock generator 101 (see FIG. 1) is applied to the respective switches 104, 301 and 302. The clock signal may be a signal shown in FIG. 4.

A clock signal (for example, a clock signal T1) among a plurality of clock signals, applied to the respective switches 104, 301 and 302, is a signal which is applied from the first sub block 102-1 to the sampling switch 104 to control the charging state of the first sub block 102-1. Simultaneously, the clock signal T1 is also applied to the remaining sub blocks 102-2 through 102-5. That is, the clock signal T1 is applied to the reset switch 302 of the second sub block 102-2 to control the reset state of the second sub block 102-2. Also, the clock signal T1 is applied to the transfer switch 301 of the third sub block 102-3 to control the transfer state of the third sub block 102-3. Likewise, clock signals T2 through T5 are applied to the respective sub blocks 102-1 through 102-5 in a manner similar to that in which the clock signal T1 is applied to the respective sub blocks 102-1 through 102-5.

Hereinafter, the operation of the FIR filter according to the current embodiment will be described with reference to FIGS. 3 and 4. Here, it is assumed that clock signals T1 through T5 shown in FIG. 4 are applied to the FIR filter of FIG. 3 and the switches of the FIR filter are turned on when the clock signals T1 through T5 go “high.” It should be apparent however other embodiments are also possible, in which the switches turn on when the clock signals become low. The clock signals T1 through T5 shown in FIG. 4 are signals in which a unit pulse is repeated periodically. Also, a (n+1)-th clock signal may be a signal delayed by the length 401 of a unit pulse from a n-th clock signal. For example, the clock signal T1 is a clock signal in which a unit pulse appears every T period, and the clock signal T2 is a clock signal which has the same period as that of the clock signal T1 and is delayed by the length 401 of the unit pulse from the clock signal T1.

In a period A, the clock signal T1 is in a “high” state and the remaining clock signals T2 through T5 are in a “low” state. Accordingly, the first, fourth and fifth sub blocks 102-1, 102-4 and 102-5 to which the clock signal T1 is applied through their input switches 104 are in the charging state, and input signals are stored in the respective sample storage units 103 of the first, fourth and fifth sub blocks 102-1, 102-4 and 102-5. However, the second sub block 102-2 to which the clock signal T1 is applied through its reset switch 302 is in the reset state, and the third sub block 102-3 to which the clock signal T1 is applied through its transfer switch 301 is in the transfer state.

Thereafter, in a period B, the clock signal T2 goes “high” and the remaining clock signals T1, T3, T4 and T5 are in the “low” state. Accordingly, the first, second and fifth sub blocks 102-1, 102-2 and 102-5 to which the clock signal T2 is applied through their input switches 104 are in the charged state, the third sub block 102-3 to which the clock signal T2 is applied through its reset switch 302 are in the reset state, and the fourth sub block 102-4 to which the clock signal T2 is applied through its transfer switch 301 is in the transfer state. Here, in the first sub block 102-1, the clock signal T1 goes “low”, which holds a sample stored in the first sample storage unit 103-1.

A table showing the states of the first through fifth sub blocks 102-1 through 102-5 during the periods A through E is as follows.

TABLE 1

| | A | B | C | D | E |
|---|---|---|---|---|---|
| First sub block | Charging 1 | Charging 2 | Charging 3 | Charging 4 | Charging 5 |
| Second sub block | Reset | Charging 1 | Charging 2 | Charging 3 | Transfer |
| Third sub block | Transfer | Reset | Charging 1 | Charging 2 | Charging 3 |
| Fourth sub block | Charging 3 | Transfer | Reset | Charging 1 | Charging 2 |
| Fifth sub block | Charging 4 | Charging 3 | Transfer | Reset | Charging 1 |

Referring to Table 1, the first through fifth sub blocks 102-1 through 102-5 have different states for each period, and particularly one of the sub blocks 102-1 through 102-5 is in a transfer state for each period. Accordingly, in the case where an input signal is received for each period, since an output signal is generated whenever the input signal is received, decimation can be removed.

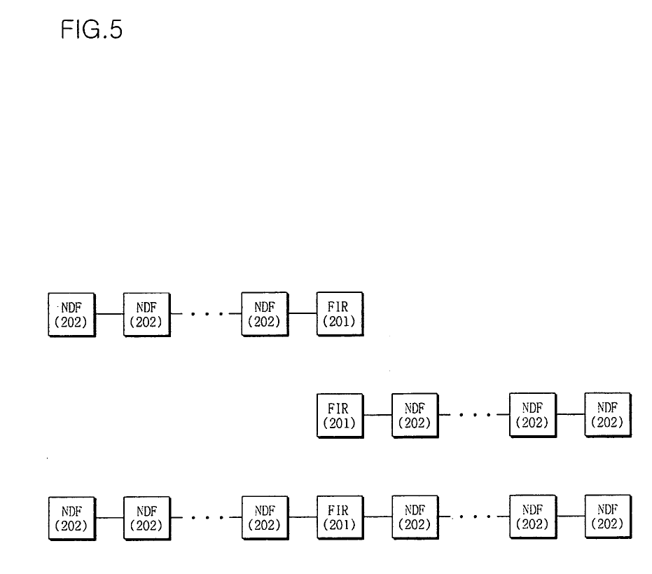

FIG. 5 is a construction diagram of a filter set according to another embodiment of the present invention.

As described above, a FIR filter according to an embodiment of the present invention has no decimation. Accordingly, by connecting a plurality of filters each having the construction of the FIR filter illustrated in FIG. 1, in a cascade structure, it is possible to improve the attenuation characteristics of a frequency response. FIG. 5 shows a filter set with a cascade structure.

In FIG. 5, “FIR” 201 represents a conventional FIR filter, and “NDF (No Decimation Filter)” 202 represents a FIR filter without decimation according to above described embodiments of the present invention.

Since the NDF 202 has no decimation, it is possible to improve attenuation characteristics by cascading a plurality of NDFs 202. The NDFs 202 connected in a cascade structure can be connected to the front or back stage of the conventional FIR filter 201. Also, it is possible to connect two groups of NDFs 202 connected in series respectively to the front and back stages of the conventional FIR filter 201. The number of NDFs 202 connected in series is not limited, and a frequency response can be improved so that it appears in the waveform of a sinc^{N} function.

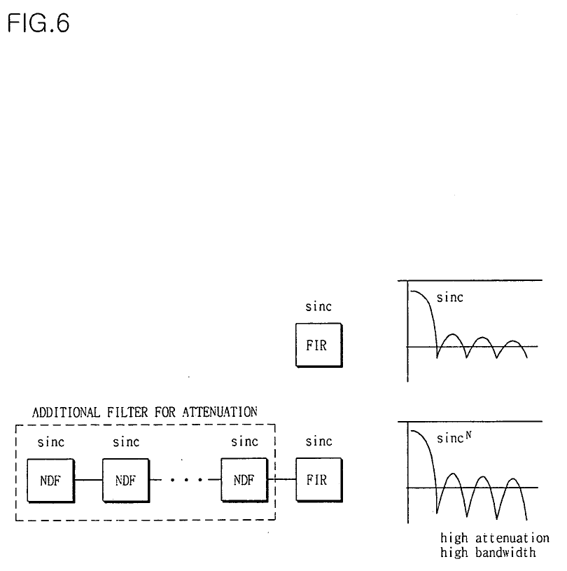

FIG. 6 shows a filter set where a plurality of NDFs are connected to a conventional FIR filter, according to an embodiment of the present invention, and the frequency characteristics of the filter set.

Referring to FIG. 6, the frequency characteristics of the conventional FIR filter appear in the waveform of a sinc function. However, by connecting the NDFs without decimation to the conventional FIR in a cascade structure, the frequency characteristics of the filter set can be improved so that it appear in the waveform of a sinc^{N} function.

Comparing the frequency characteristics of the conventional FIR filter with the frequency characteristics of the filter set according to the current embodiment, more portions of the frequency-characteristics function of the filter set are below an attenuation level which is a requirement for a filter, than in the conventional FIR filter.

Accordingly, the bandwidth of a notch is widened and an anti-aliasing function is improved, and as a result the filter set according to the current embodiment can be applied to a broadband system.

In other words, in the case of a filter set constructed by cascading a plurality of NDFs to the front or back stage of a conventional FIR filter with decimation, attenuation characteristics can appear maximally in the waveform of a sinc^{N} function and bandwidth characteristics can also be improved. As a result, the filter set according to the current embodiment can be applied to a broadband system.

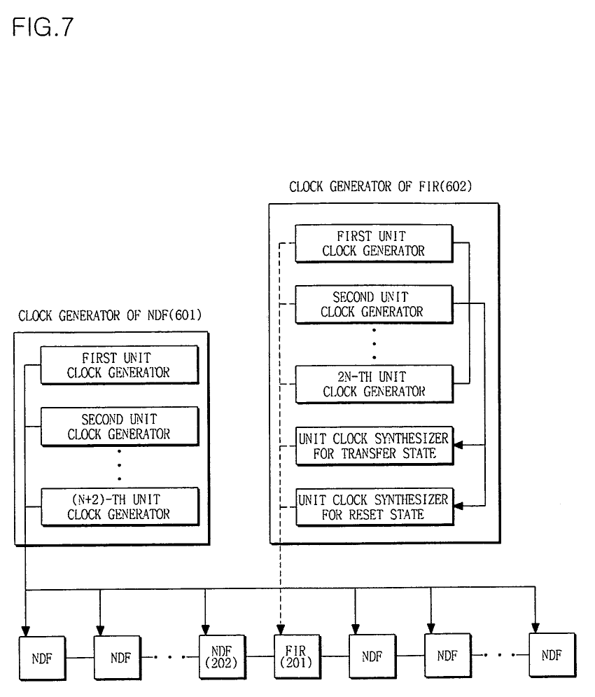

FIG. 7 is a block diagram showing a clock generator 601 of a NDF 202, according to an embodiment of the present invention, and a clock generator 602 of a conventional FIR filter 201.

FIG. 7 shows a case where the NDF 202 and the conventional FIR filter 201 utilize independent clock systems respectively. In the case of the NDF 202, at least N+2 clock signals are needed. That is, N clock signals among the N+2 clock signals are needed to control a moving average, that is, to control N charging states, one of the remaining clock signals is needed to control a transfer state, and the remaining one clock signal is needed to control a reset state. Each clock signal does not control only one of the charging state, transfer state and reset state, but controls the state of each sub block individually.

In the case of the filter set according to the current embodiment, at least 2N unit clock signals are needed, and a clock signal for controlling a transfer state and reset state can be generated by combining the unit clock signals.

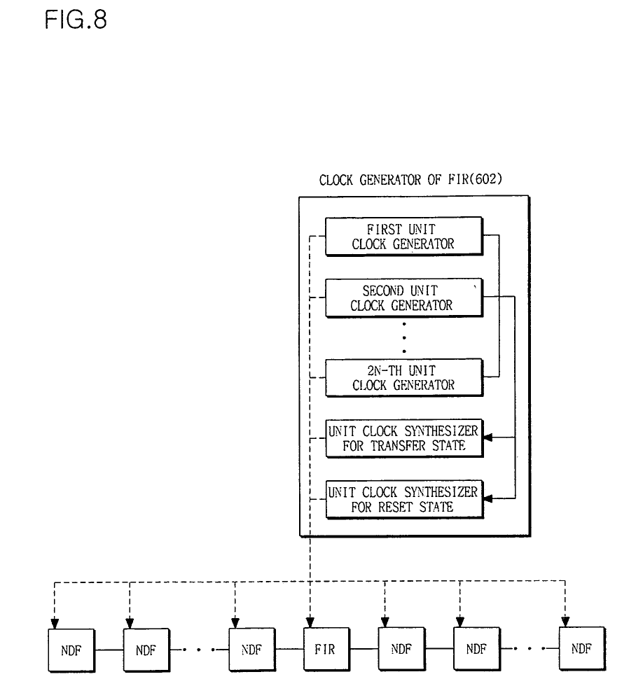

FIG. 8 is a block diagram of a clock generator which NDFs and a conventional FIR filter share, according to another embodiment of the present invention. Since a clock signal for controlling the states of the NDFs consists of a plurality of unit clock signals delayed by a basic unit pulse with respect to each other, a clock signal obtained by properly composing unit clock signals generated by a clock system of a FIR filter can be used as a clock signal that is to be applied to the NDFs.

As a result, since a FIR filter according to an embodiment of the present invention has no decimation, it is possible to connect a plurality of NDFs and a conventional FIR filter in a cascade structure and improve the attenuation characteristics and bandwidth characteristics of a filter.

It will be apparent to those skilled in the art that various modifications and variations can be made in the present invention without departing from the spirit or scope of the invention. Thus, it is intended that the present invention covers the modifications and variations of this invention provided they come within the scope of the appended claims and their equivalents.

What is claimed is:

1. A finite impulse response (FIR) filter, comprising: a clock generator configured to generate a plurality of clock signals that are different from each other; and
N+2 sub blocks each including N sample storage units, each sample storage unit storing a received sample, N being an integer.
Wherein each sub block is in a state among N charging states for storing the received sample, a transfer state for outputting the stored sample and a reset state for operation initialization, and wherein the N charging states, the transfer state, and the reset state are changed sequentially in response to one or more of the plurality of clock signals.

2. The FIR filter of claim 1, wherein each of the plurality of clock signals is used to control one of the N charging states of a first sub block among the N+2 sub blocks, the reset state of a second sub block among the N+2 sub blocks and the transfer state of a third sub block among the N+2 sub blocks.

3. The FIR filter of claim 1, wherein each of the plurality of clock signals is a signal in which a unit pulse is repeated periodically, and a (n+1)th clock signal among the plurality of clock signals is a signal delayed by a length of the unit pulse from a n-th clock signal among the plurality of clock signals.

4. The FIR filter of claim 1, wherein each sub block comprises:
a first switch unit configured to control the N charging states of the sub block in response to one or more of the plurality of clock signals generated by the clock generator; and
a second switch unit configured to control at least one of the transfer state and the reset state of the sub block in response to one or more of the plurality of clock signals.

5. The FIR filter of claim 4, wherein the second switch unit comprises:
a transfer switch connected to an output terminal of the FIR filter; and
a reset switch connected to a reset terminal of the FIR filter.

6. The FIR filter of claim 1, wherein N is 3.

7. A FIR filter, comprising:
a clock generator configured to generate a plurality of clock signals that are different from each other; and
a plurality of sub blocks, each being in a state among N charging states for storing a received sample, a transfer state for outputting the stored sample and a reset state for operation initialization, N being an integer,
wherein the N charging states, the transfer state and the reset state are changed in response to one or more of the plurality of clock signals generated by the clock generator, at least one sub block among the plurality of sub blocks being in the transfer state.

8. The FIR filter of claim 7, wherein one or more of the plurality of clock signals generated by the clock generator is used to control one of the N charging states of a first sub block among the plurality of sub blocks, and simultaneously control one of the transfer state and a reset state of a second sub block among the plurality of sub blocks.

9. The FIR filter of claim 7, wherein each sub block comprises:
N sample storage units configured to store therein a received sample;
a first switch unit connected to the N sample storage units to control the N charging states of the sub block in response to one or more of the plurality of clock signals received from the clock generator; and
a second switch unit connected to the N sample storage units to control at least one of the transfer state and the reset state of the sub block in response to one or more of the plurality of clock signals.

10. The FIR filter of claim 7, wherein the plurality of sub blocks comprises N+2 sub blocks.

11. A finite impulse response (FIR) filter, in which a plurality of FIR filter units are connected in a cascade structure, comprising:
a plurality of sub blocks, each being in a state among N charging states for storing a received sample, a transfer state for outputting the stored sample, and a reset state for operation initialization, N being an integer,
wherein the N charging states, the transfer state, and the reset state are changed sequentially in response to an external clock signal, and at least one sub block of the plurality of sub blocks is in the transfer state.

12. The FIR filter of claim 11, further comprising a clock generator generating a plurality of clock signals configured to generate the external clock signal.
